(19) United States
(12) Patent Application Publication
(10) Pub. No.: US 2010/0026614 A1
(43) Pub. Date: Feb. 4, 2010

(54) METHOD AND APPARATUS FOR AUTO-COMMISSIONING OF LED BASED DISPLAY CONFIGURATIONS

(75) Inventors: Robin John Blackwell, Redhill (GB); David Martin Avery, Surrey (GB); Phil Anthony Jamieson, Surrey (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/302,082

(22) PCT Filed: Apr. 11, 2007
(86) PCT No.: PCT/IB2007/051301

§ 371 Date: Aug. 7, 2009

Related U.S. Application Data
(60) Provisional application No. 60/802,937, filed on May 24, 2006.

(51) Int. Cl. G09G 3/32

(52) U.S. Cl. 345/82

(57) ABSTRACT

A method of auto-commissioning a display configuration (10) includes providing a plurality of LED modules (12) arranged in a multi-dimensional array of the display configuration. Each LED module (12) is operable between a listen mode of operation and a pass through mode of operation. Each LED module (12) further comprises at least two ports (20), each port having a predefined configuration and orientation. A number of adjacent ones of the LED modules in the multi-dimensional array are coupled together via a complementary port of the respective LED modules. The method further includes coupling a controller (18) to a single access point (19) in the display configuration, wherein the single access point comprises an available port of the plurality of LED modules that is not coupled with another port of the plurality of LED modules. An auto-commissioning of the plurality of LED modules is implemented via the controller and the single access point, wherein the auto-commissioning is a function of (i) the listen and pass through modes of operation of the LED modules and (ii) the port configurations and orientations.

The present embodiments relate generally to solid state lighting systems and more particularly, to a method and apparatus for auto-commissioning of LED based display configurations.

With the advent of Solid State Lighting (SSL), it is becoming possible to realize very complex dynamic and static colour lighting effects. These effects may be based on a number of inputs, such as controllers, sensors and even audio/video (AV) streams. In addition to individual light emitting diode (LED) devices, the LEDs can be used in a matrix configuration to act as a display for multimedia content, e.g. a video wall.

An issue arises due to the variety of configurations possible for matrix displays, e.g. varying pitch, matrix size and shape. Although a given configuration can be preconfigured in a static way, such a static pre-configuration is time consuming and not flexible. A main disadvantage with current SSL systems is that the matrix size, shape and pitch must either be preconfigured or programmed by hand at installation time.

It would thus be desirable to have a method for creating an arbitrary size and shape matrix display and automatically detecting its size and shape. Accordingly, an improved method and system for overcoming the problems in the art is desired.

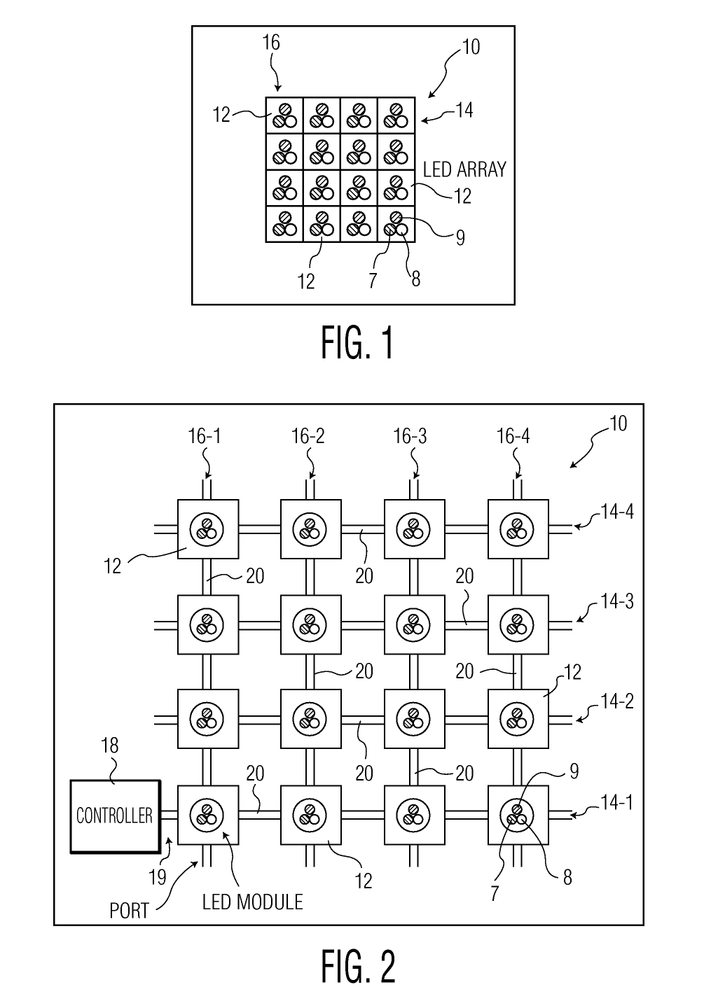

FIG. 1 is a block diagram view of an LED based display configuration according to an embodiment of the present disclosure;

FIG. 2 is a simplified schematic block diagram view illustrating the LED based display configuration of FIG. 1 in greater detail according to an embodiment of the present disclosure;

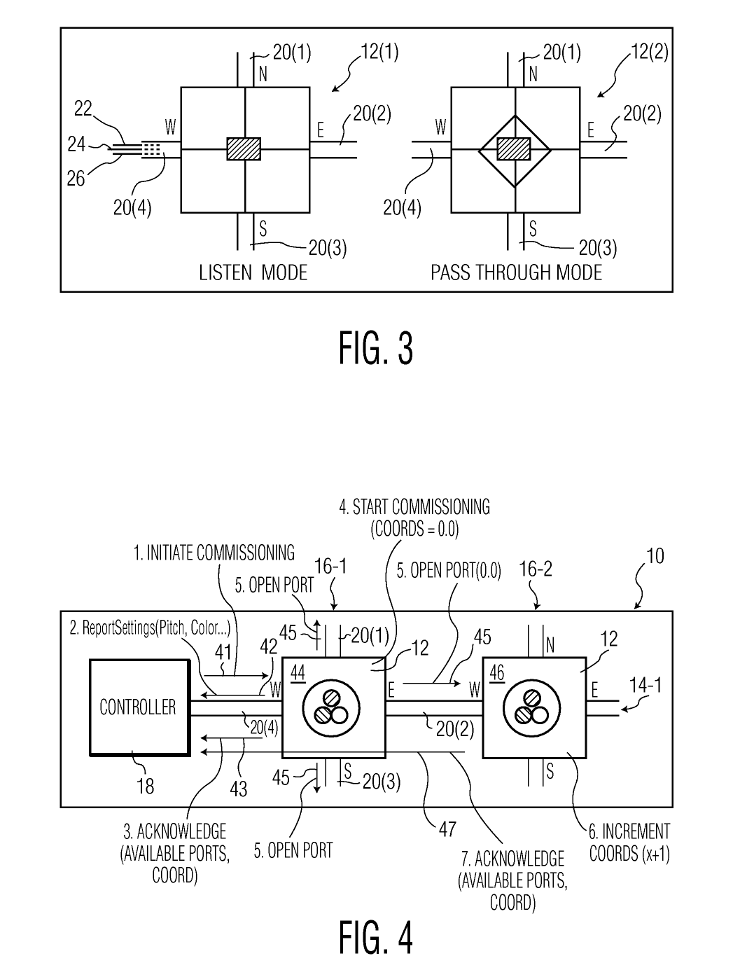

FIG. 3 is a schematic block diagram view of an LED module in a first mode and a second mode for use in the LED based display configuration according to the embodiments of the present disclosure; and

FIG. 4 is a block diagram view of a partial LED matrix array for illustrating a method of auto-commissioning of an LED based display configuration according to an embodiment of the present disclosure.

In the figures, like reference numerals refer to like elements. In addition, it is to be noted that the figures may not be drawn to scale.

FIG. 1 is a block diagram view of an LED based display configuration 10 according to an embodiment of the present disclosure. For example, a number of LED modules 12 are arranged in an interconnected matrix, the matrix including rows 14 and columns 16. For illustrative purposes only, as shown in FIG. 1, the interconnected matrix comprises a four-by-four (4×4) square matrix of LED modules 12. In one embodiment, each LED module 12 is configured with the capability of emitting Red, Green, and Blue colour light in combination, indicated by reference numerals 7, 8 and 9, respectively. In another embodiment, the matrix 10 can comprise up to many thousands of interconnected LED modules 12 in a matrix. Furthermore, the interconnected matrix can also include any two dimensional (2-D) or three dimensional (3-D) shape. Moreover, in another embodiment, the LED modules 12 comprise single colour modules. In yet another embodiment, the LED modules 12 of the matrix 10 comprise different colour combination modules.

Each LED module used in connection with the present embodiments comprises at least two ports, each port including one or more of an electrical, optical, or other signal line or lines, such as a bus. The ports of each LED module are oriented in a predefined configuration and orientation, such as in a compass orientation (North, East, South and West) or in a polar coordinate orientation, with respect to the module and each other. Each LED module further contains information regarding its capabilities.

FIG. 2 is a simplified schematic block diagram view illustrating the LED based display configuration of FIG. 1 in greater detail according to an embodiment of the present disclosure. In particular, FIG. 2 is an expanded view of the interconnected matrix 10 of LED modules 12 of FIG. 1 with controller 18 coupled to the LED module 12 located at row 14-1 and column 16-1. Controller 18 is coupled to the LED module 12 at a single access point, generally indicated by reference numeral 19. Each square 12 in the matrix 10 is a LED module, each of which has a number of associated ports, indicated by reference numeral 20, as will be discussed further herein with reference to FIG. 3. The orientation of the ports 20 associated with each LED module is of importance. In the example of FIG. 2, only four ports are shown with respect to each of the LED modules. However, there may be more ports depending on the orientation and shape required for a given interconnected LED module application. Furthermore, the ports may also be characterized by different orientations and/or angles, e.g. circular, diagonal, etc.

At system initialization, or in response to a system initialization, all ports 20 of the matrix of LED modules are in a closed state. Controller 18 is coupled or connected to a single LED module via a single port 20. In one embodiment, the single LED module comprises a module located at an edge of the interconnected matrix of LED modules. Controller 18 comprises any suitable controller for performing various functions as disclosed herein for the auto-commissioning of the LED module array according to the embodiments of the present disclosure.

In operation, the controller 18 opens the port 20 it is connected to and requests the LED module 12 to begin commissioning. The initial LED module 12 then opens its subsequent ports and forwards the commissioning message on, incrementing a position counter, dependent on the subsequent port opened. Auto-commissioning will be discussed further herein with respect to FIG. 4, following the discussion with respect to additional details of the LED modules.

Turning now to FIG. 3, FIG. 3 is a schematic block diagram view of an LED module in a first mode as indicated by reference numeral 12(1) and a second mode as indicated by reference numeral 12(2) for use in the LED based display configuration according to the embodiments of the present disclosure. In one embodiment, the first mode 12(1) and the second mode 12(2) represent two communication states of the LED module. The first communication state or mode 12(1) represents a listen mode. The second communication state or mode 12(2) represents a pass through mode. In addition, each port 20 includes a power, ground, and an optional data line or lines, indicated by reference numerals 22, 24 and 26, respectively. Only one set of power, ground and optional data line has been illustrated for simplicity. In one embodiment, data is transmitted via the power line 22.

In the listen mode 12(1), a signal received on any input port (i.e., 20(1) or 20(2) or 20(3) or 20(4)) of a corresponding LED module 12 terminates at that LED module. That is, all communications that are sent to the LED module and received at an input port are not passed on to subsequent ports. Placing the LED modules of the display configuration in the listen mode creates a Unicast network. In one embodiment, a cycling of power to the display configuration between ON and OFF power states places the LED modules in the listen mode. Other suitable methods of placing the LED modules in the listen mode could also be used.

In the pass through mode 12(2), any signal received on an input port (i.e., 20(1) or 20(2) or 20(3) or 20(4)) of the corresponding LED module 12 passes through the LED module and onto the subsequent ports (i.e., 20(1) or 20(2) or 20(3) or 20(4)) of the LED module. That is, all signals entering any port of an LED module in the pass through state are sent out via the subsequent ports to all other connected modules. Placing the LED modules of the display configuration in the pass through mode creates a broadcast network. In one embodiment, in response to a given LED module acting upon an auto-commissioning instruction from the controller or from another immediately adjacent LED module within the display configuration, the corresponding LED module places itself into the pass through mode.

In one embodiment, the ports 20 of the LED module 12 are arranged in a North 20(1), East 20(2), South 20(3) and West 20(4) compass based configuration. In another embodiment, the ports of the LED module may take other coordinate systems into account, for example, polar coordinates. When all ports 20 of an LED module 12 are opened, messages can be broadcast across the entire matrix 10 with a corresponding position embedded in each module, respectively. In yet another embodiment, a simpler implementation is possible, for example, with the use of an overlay connected to each LED module to a supply power (not shown). In the latter instance, only data would be sent across the ports.

The LED modules 12 may be arranged in a sheet and cut, or snapped off, into any desired shape. The controller 18 is configured to automatically determine the shape of the resultant array of LED modules 12 in response to being connected as indicated herein. The embodiments of the present disclosure also cope with irregular array shapes, including those with missing internal LED modules. Knowledge of the LED module array's topology can also be used to determine routing information. This is particularly useful if a mesh is envisaged, in which case, LED units that fail can be bypassed.

In one embodiment, determination of the physical size of the matrix of LED modules 12 requires only the module pitch (unless the sheet of LED modules is irregular). The pitch can either be (i) programmed into the controller or (ii) reported by the modules, wherein the modules are arranged in a physical sheet. The same principle can be applied to the port orientations. That is, the port orientations of the respective LED modules can either be (i) programmed into the controller or (ii) reported by each of the modules, wherein the modules are arranged in a physical sheet. Furthermore, the capabilities (e.g., single colour, multicolour, etc.) of each respective LED module can either be (i) programmed into the controller, wherein all LED modules are of similar capability or (ii) reported by each of the respective modules, where one or more of the LED modules of the display configuration are of similar capability or of differing capabilities.

Once commissioned, the LED display 10 is configured, for example, via controller 18, to operate in a broadcast manner to prevent all messages going through the first module. However, during commissioning, a Unicast network must be used, as it is important for a module to know that it has only received a message from an adjacent module. This can be achieved via (1) sending the Unicast auto-commissioning communications through the ports and (2) sending broadcast data through the power layer or by each module, enabling and disabling an associated bus (not shown) at the corresponding module's location. For the latter solution, the controller enables the entire bus after the auto-commissioning has been completed.

Again, FIG. 3 illustrates the two communication states of an LED module. At power up, all modules of the LED based display configuration are placed in the Listen Mode 12(1), for example, via controller 18. In the Listen Mode, all communications are sent to a corresponding LED module via one of its ports and are not passed on to its subsequent ports. This creates a Unicast network. After auto-commissioning has been completed, all LED modules are placed in the Pass Though Mode 12(2). In the pass through mode, all signals entering an LED module at an input port are sent out to all other connected modules. This creates a broadcast network.

FIG. 4 is a block diagram view of a partial LED matrix array 10 for illustrating a method of auto-commissioning of an LED based display configuration according to an embodiment of the present disclosure. In the illustration of FIG. 4, the LED modules 12 include compass based ports (North, East, South and West), generally indicated by reference numerals 20(1), 20(2), 20(3) and 20(4), respectively. In this example, all modules 12 of the matrix array are each set to have the coordinates (x=0, y=0) at start-up. In addition, each of the LED modules 12 is configured to only reset its respective coordinates based on the first message received, and to ignore all subsequent auto-commissioning messages.

The method of auto-commissioning of an LED based display configuration according to an embodiment of the present disclosure includes the following:

In a first step, generally indicated by reference numeral 41, the controller 18 is coupled to a desired LED module, preferably, an edge module. In the example of FIG. 4, the first LED module corresponds to the LED module located at the intersection of row 14-1 and column 16-1. Coupling the controller to the desired LED module triggers a start commissioning signal (i.e., initiate auto-commissioning) which is sent via port 20(4) to the associated LED module. Prior to beginning of the auto-commissioning process, all LED modules of the display configuration are placed in the listen mode 12(1), for example, using an appropriate control signal or sequence of signals, such as corresponding to a power ON/OFF cycle.

In a second step, generally indicated by reference numeral 42, responsive to the start auto-commissioning signal, the first LED module acknowledges receipt of the start auto-commissioning signal to the controller 18. In an alternate embodiment, an optional step includes the first LED module also reporting back to the controller one or more details of the LED module and/or matrix type. The details of the matrix type can include, for example, colours supported and a pitch. However, in the absence of such an alternate embodiment, another method is required for informing the controller of pitch and colours supported. For example, the controller may be informed of pitch and colours supported via suitable preconfiguration information, user entered information, or other suitable method for informing the controller of the pitch and colours supported by the LED modules.

Subsequent to providing the acknowledgement signal to the controller, the first LED module assigns itself as the origin of the LED module display configuration, generally indicated by reference numeral 43. For example, the origin comprises coordinates (x=0, y=0) for a planar display configuration.

The first LED module then sends an acknowledgement to the controller, indicating the assigned coordinates and an indication of its available active ports, generally indicated by reference numeral 44. In addition, the controller stores the assigned coordinates and the indication of available active ports.

Subsequently, the first LED module opens each of its active ports and sends out an auto-commissioning signal to all adjacent LED modules, generally indicated by reference numeral 45. The auto-commissioning signal sent out contains the coordinates of the sending module. One exception is that the sending module will not forward the auto-commissioning signal to the port that an auto-commissioning message has already been received through. In addition, an auto-commissioning signal sent via an open active port for which the subsequent module has already been assigned a coordinate will be ignored by the subsequent module.

In a next step as generally indicated by reference numeral 46, in response to receiving the auto-commissioning signal, the receiving module assigns coordinates to itself based on (i) the sending module coordinates and (ii) its port that the auto-commissioning signal was received on.

Responsive to the LED module assigning itself coordinates and becoming a newly commissioned module, the LED module then sends an acknowledgement, as indicated by reference numeral 47, to the controller with the coordinates it has assigned to itself and an identification of its available active ports. The controller then stores the assigned coordinates and the indication of available active ports.

This procedure (i.e., steps 41-47 discussed above) continues until all LED modules of the display configuration have been assigned a coordinate. An additional step can include, further in response to the auto-commissioning signal, each LED module visually indicating that it has been commissioned and for which all active ports are identified. For example, the visual indication may comprise, for example, a flash being emitted from the respective commissioned module.

As the controller 18 receives acknowledgments from the LED modules, it determines the shape of the LED matrix display and determines when there are no more available active ports remaining. The respective coordinates of the modules can be stored (i) on the respective modules, (ii) the controller, (iii) or both. Storing coordinates on the modules would require either adding non-volatile memory to each module or having to re-commission after every power down. One advantage of re-commissioning after every power down is that the matrix display could be reconfigured by some physical modification and then automatically re-commissioned at the next start up. If stored on the controller, each module would require a preconfigured unique address in a suitable memory of the controller (e.g., ROM or other memory), which would enable the controller to map between coordinates and modules.

In a further embodiment, the auto-commissioning method comprises an additional step, wherein after initial commissioning, the controller reassigns the origin of the display configuration or matrix. For example, if the controller were plugged in half way up the side of a matrix, it would have negative coordinates at the bottom. In this example, the controller issues a coordinate re-centre command signal that is sent out with the required offset in terms of coordinates x and y. Responsive to the coordinate re-centre command, each of the modules then reassigns its respective coordinates based on this offset. This additional auto-commissioning step or mechanism is advantageous for use in applications where multiple display configurations or matrices are to be connected together, as each set of display configurations or matrices would require an offset to enable a number of them to act as a single larger display configuration or matrix.

In yet another embodiment, the auto-commissioning method combines the power and auto-commissioning communication so that both are delivered through the active ports of the modules. In this way, controller 18 would power up the LED modules as they are commissioned. In this embodiment, however, care must be taken to ensure that there are no issues with providing the entire matrix power through individual modules. Also, each of the power and data lines of an active port of a corresponding LED module includes an appropriately terminated design.

According to still another embodiment, the ports 20 of the LED modules 12 are configured according to a coordinate system (other than compass based or Cartesian), for example, a polar coordinate system. Furthermore, the embodiments of the present disclosure are not fixed to sheets of LED modules, but could also extend to LED modules connected in an arbitrary fashion. However, this later configuration would likely require further user intervention.

Still further, an additional step in the method of auto-commissioning according to the embodiments of the present disclosure also includes using communication propagation delays to automatically detect the distance between LED modules. Yet still further, the embodiments of the present disclosure can be utilized in lighting applications, for example, in any field requiring LED based displays.

In another embodiment, information obtained via the auto-commissioning method as disclosed herein could be further utilized in determining the boundary of the shape of the matrix of LED modules. For example, if a matrix of LED modules of a given shape and size were cut to a different desired shape and size, wherein the action of cutting power connections, control connections or damaging the LED modules renders select ones of the LED modules to no longer work, then in response to a subsequent performing of the auto-commissioning method, the information obtained from the auto-commissioned LED modules can be appropriately analyzed to determine a boundary of the modified shape of the matrix of LED modules. The boundary would be defined by those LED modules on a perimeter of the modified matrix that remain functional subsequent cutting of the matrix to the different desired shape and size. In other words, the method further comprises determining a boundary of a shape and size of the plurality of LED modules arranged in the multi-dimensional array of the display configuration in response to information obtained from the auto-commissioning of the plurality of LED modules. The boundary is defined by LED modules of a perimeter of the multi-dimensional array of the display configuration, wherein the LED modules of the perimeter remain functional subsequent to a modification of the multi-dimensional array to a desired shape and size.

Accordingly, the embodiments of the present disclosure provide for a fully dynamic and automated way of designing LED matrix based displays. The matrix can effectively be cut to size, a controller connected at any single access point and the system, according to the embodiments of the present disclosure, will automatically determine the physical size and shape of the connected LED matrix. The physical size is particularly important to determine the resolution of the display configuration. This then enables dynamic discovery of the matrix lighting network. Another benefit is that a single controller design can be used across all matrix shapes and sizes, thus increasing reuse and reducing an overall SSL system cost.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

In addition, any reference signs placed in parentheses in one or more claims shall not be construed as limiting the claims. The word “comprising” and “comprises,” and the like, does not exclude the presence of elements or steps other than those listed in any claim or the specification as a whole. The singular reference of an element does not exclude the plural references of such elements and vice-versa. One or more of the embodiments may be implemented by means of hardware comprising several distinct elements, and/or by means of a suitably programmed computer. In a device claim enumerating several means, several of these means may be embodied by one and the same item of hardware. The mere fact that certain measures are recited in mutually different dependent claims does not indicate that a combination of these measures cannot be used to an advantage.

1. A method of auto-commissioning a display configuration comprising:
providing a plurality of LED modules arranged in a multi-dimensional array of the display configuration, wherein each LED module is operable between a listen mode of operation and a pass through mode of operation, wherein each LED module further comprises at least two ports, each port having a predefined configuration and orientation, further wherein a number of adjacent ones of the LED modules in the multi-dimensional array are coupled together via a complementary port of the respective LED modules;
coupling a controller to a single access point in the display configuration, wherein the single access point comprises an available port of the plurality of LED modules that is not coupled with another port of the plurality of LED modules; and
implementing an auto-commissioning of the plurality of LED modules via the controller and the single access point, wherein the auto-commissioning is a function of (i) the listen and pass through modes of operation of the LED modules and (ii) the port configurations and orientations.

2. The method of claim 1, wherein implementing the auto-commissioning includes:
placing each LED module of the plurality of LED modules in the listen mode of operation;
sending an auto-commissioning signal from the controller to a first LED module corresponding to the single access point;
responsive to receipt of the auto-commissioning signal, the first LED module (i) acknowledges receipt of the auto-commissioning signal to the controller, (ii) assigns itself coordinates corresponding to an origin of the plurality of the LED modules of the multi-dimensional array of the display configuration, (iii) sends a further acknowledgement to the controller, indicating the assigned coordinates and providing information regarding an active availability of its ports, and (iv) opens its active ports and sends out an auto-commissioning signal to all adjacently coupled LED modules, wherein the auto-commissioning signal contains the assigned coordinates of the sending LED module;
responsive to receipt of the auto-commissioning signal, a subsequent LED module (i) assigns itself coordinates based on both (a) the coordinates of the sending LED module and (b) the corresponding port upon which the auto-commissioning signal was received, (ii) sends an acknowledgement to the controller, indicating the assigned coordinates and providing information regarding an active availability of its ports, and (iii) opens its active ports and sends out an auto-commissioning signal to all adjacently coupled LED modules, wherein the auto-commissioning signal contains the assigned coordinates of the sending LED module; and
repeating in response to auto-commissioning signals received by additional subsequent LED modules (i) the assigning of corresponding coordinates, (ii) the sending of corresponding acknowledgements to the controller, and (iii) the opening of corresponding active ports and the sending out further corresponding auto-commissioning signals until all operable LED modules of the plurality of have been assigned coordinates, wherein the LED modules become commissioned LED modules upon the assignment of their respective coordinates.

3. The method of claim 2, wherein the LED module sending the auto-commissioning signal will not (a) forward the auto-commissioning signal to a port through which an auto-commissioning signal has already been received or (b) forward the auto-commissioning signal through a port for which a subsequent LED module has already been assigned coordinates.

4. The method of claim 2, wherein responsive to receipt of the auto-commissioning signal, the first LED module reports back to the controller with one or more details of (a) the first LED module or (b) matrix type, wherein the matrix type includes one or more of colours supported by the first LED module and a pitch.

5. The method of claim 2, wherein responsive to each acknowledgement containing coordinates of a sending LED module and an indication of its available active ports, the controller stores the coordinates of the sending LED module and the indication of its available active ports.

6. The method of claim 2, wherein a sending LED module becomes a newly commissioned module in response to sending a corresponding acknowledgement to the controller.

7. The method of claim 2, wherein responsive to the acknowledgement signals received from commissioned LED modules, the controller determines a shape of the LED display configuration based upon the coordinates and characteristics of the active ports of the commissioned LED modules and whether additional LED modules have yet to be assigned coordinates.

8. The method of claim 1, wherein placing each LED module of the plurality of LED modules in the listen mode of operation occurs in response to a control signal or sequence of signals corresponding to a power ON/OFF cycle.

9. The method of claim 1, wherein placing the LED modules of the multi-dimensional array of the display configuration in the listen mode of operation creates a unicast type network.

10. The method of claim 9, further wherein for the listen mode of operation, any signal received on a port of an LED module terminates at the corresponding LED module.

11. The method of claim 1, wherein placing the LED modules of the multi-dimensional array of display configuration in the pass through mode of operation creates a broadcast type network.

12. The method of claim 11, further wherein for the pass through mode of operation, any signal received on a port of an LED module passes through the corresponding LED module and onto subsequent ones of the at least two ports of the corresponding LED module.

13. The method of claim 1, wherein auto-commissioning further includes using propagation delays to automatically detect a distance between LED modules.

14. The method of claim 1, wherein the array of LED modules comprises one selected from the group consisting of a two-dimensional (2-D) matrix array of LED modules and a three-dimensional (3-D) matrix array of LED modules.

15. The method of claim 1, wherein the at least two ports comprise four ports, and further wherein the four ports are oriented in a compass based configuration.

16. The method of claim 1, wherein the at least two ports are oriented in a configuration characterized by the use of polar coordinates.

17. The method of claim 1, wherein subsequent to an initial auto-commissioning, the method further comprising:
issuing, via the controller, a coordinate re-centre command signal to the plurality of commissioned LED modules, wherein the coordinate re-centre command signal contains a required amount of offset in terms of appropriate coordinates needed to perform a coordinate re-centre operation on the plurality of LED modules; and
in response to receipt of the coordinate re-centre command signal, the commissioned LED modules reassign their respective coordinates based upon the offset.

18. The method of claim 17, further comprising:
coupling a second plurality of LED modules arranged in a second multi-dimensional array of a second display configuration to the plurality of LED modules arranged in the multi-dimensional array of first display configuration prior to issuing the coordinate re-centre command signal.

19. The method of claim 1, further comprising:
reassigning an origin of the plurality of LED modules upon completion of the initial auto-commissioning.

20. The method of claim 1, further comprising:
determining a boundary of a shape and size of the plurality of LED modules arranged in the multi-dimensional array of the display configuration in response to information obtained from the auto-commissioning of the plurality of LED modules.

21. The method of claim 20, wherein the boundary is defined by LED modules of a perimeter of the multi-dimensional array of the display configuration, wherein the LED modules of the perimeter remain functional subsequent to a modification of the multi-dimensional array to a desired shape and size.

22. A display configuration featuring LED module auto-commissioning comprising:
a plurality of LED modules arranged in a multi-dimensional array of the display configuration, wherein each LED module is operable between a listen mode of operation and a pass through mode of operation, wherein each LED module comprises at least two ports, each port having a predefined configuration and orientation, further wherein a number of adjacent ones of the LED modules in the multi-dimensional array are coupled together via a complementary port of the respective LED modules; and
a controller coupled to a single access point in the display configuration, wherein the single access point comprises an available port of the plurality of LED modules that is not coupled with another port of the plurality of LED modules and wherein the controller is configured for implementing an auto-commissioning of the plurality of LED modules via the single access point, wherein the auto-commissioning is a function of (i) the listen and pass through modes of operation of the LED modules and (ii) the port configurations and orientations.
